(19) United States
(12) Patent Application Publication
(10) Pub. No.: US 2005/0146507 A1
(43) Pub. Date: Jul. 7, 2005

(54) Method and apparatus for interfacing with a graphical user interface using a control interface

(76) Inventor: Marc A. Viredaz, Sunnyvale, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/752,355

(22) Filed: Jan. 6, 2004

(51) Int. Cl. G09G 5/00

(52) U.S. Cl. 345/169; 345/156; 345/168; 345/173; 345/179; 345/184

(57) ABSTRACT

A method, system, and apparatus is disclosed for interfacing with a graphical user interface. In one embodiment, the graphical user interface is displayed on a first computing arrangement. One or more control graphical components are displayed on a second computing arrangement. The control graphical components abstract functions of a proper subset of graphical components of the graphical user interface and are associated with the subset of graphical components. A user input is received via the control graphical components of the second computing arrangement. The user input is communicated to the first computing arrangement for controlling the associated portions of the graphical user interface. A state of the graphical user interface of the first computing arrangement is communicated to the second computing arrangement. The control graphical components of the second computing arrangement are updated based on the state of the graphical user interface.

### FIELD OF THE INVENTION

The present disclosure relates in general to computer interfaces, and in particular to control of graphical user interfaces.

### BACKGROUND

Computers have become more powerful and ubiquitous over the last few decades. The form of computers has also evolved over that time. Although computers are traditionally seen as desktop boxes with keyboards and monitors attached, various forms of computers are changing this perception. Advances in technology are resulting in computers that are small, low-power, and inexpensive so that people can use them wherever they go. Other computers are built into consumer products such as cell phones or DVD players. These computers may perform in such a way the users aren't aware they are interacting with a computer.

As computers are further adapted for use in daily activities, new ways of interfacing with the computer will evolve. One example relates to computers integrated into home entertainment centers. These computers may operate general-purpose desktop software, but display video output on a high-definition TV and send audio to a high-fidelity sound system. Of course, standard input devices such as mice and keyboards can be used to interact with such a computer. However, these devices are not particularly well suited for use by a person sitting on a couch. Push button remote controls may be adapted to interface with a home entertainment computer, although remote controls are only useful in performing simple tasks. Therefore, a way of interfacing with computers that is more flexible than traditional methods will be desirable.

### SUMMARY

A method, system, and apparatus is disclosed for interfacing with a graphical user interface. In one embodiment, the graphical user interface is displayed on a first computing arrangement. One or more control graphical components are displayed on a second computing arrangement. The control graphical components abstract functions of a proper subset of graphical components of the graphical user interface and are associated with the subset of graphical components. A user input is received via the control graphical components of the second computing arrangement. The user input is communicated to the first computing arrangement for controlling the associated portions of the graphical user interface. A state of the graphical user interface of the first computing arrangement is communicated to the second computing arrangement. The control graphical components of the second computing arrangement are updated based on the state of the graphical user interface.

### BRIEF DESCRIPTION OF THE DRAWINGS

FIG. 1 illustrates an arrangement of data processing devices according to various embodiments of the present invention;

FIG. 2 illustrates a relationship a handheld input device and a computer running an application program according to embodiments of the present invention;

FIG. 3 illustrates an example mapping of window controls between a control graphical user interface and a display graphical user interface according to various embodiments of the present invention;

FIG. 4 illustrates an example keyboard input area of a control graphical user interface according to various embodiments of the present invention;

FIG. 5 illustrates an example handwriting recognition input area of a control graphical user interface according to various embodiments of the present invention;

FIG. 6 illustrates an example mapping of application controls between a control graphical user interface and a display graphical user interface according to various embodiments of the present invention; and

FIG. 7 illustrates an example procedure for mapping of application controls between a control graphical user interface and a display graphical user interface according to various embodiments of the present invention.

### DETAILED DESCRIPTION

In the following description of various embodiments, reference is made to the accompanying drawings which form a part hereof, and in which is shown by way of illustration various example manners by which the invention may be practiced. It is to be understood that other embodiments may be utilized, as structural and operational changes may be made without departing from the scope of the present invention.

In general, the present disclosure relates to controlling a first graphical interface (GUI) using a second GUI. The first GUI (or “display GUI”) may be associated with one or more applications running on a computing arrangement that includes at least a display device. The second GUI (or “control GUI”) typically operates on a portable device (handheld device, tablet PC, etc.). The control GUI may be used to control the display GUI, and the display GUI may optionally send state information to the control GUI. The control GUI may use this state information to alter its own display. In this way, the handheld device can provide a dynamically adaptable control for applications of the computing arrangement.

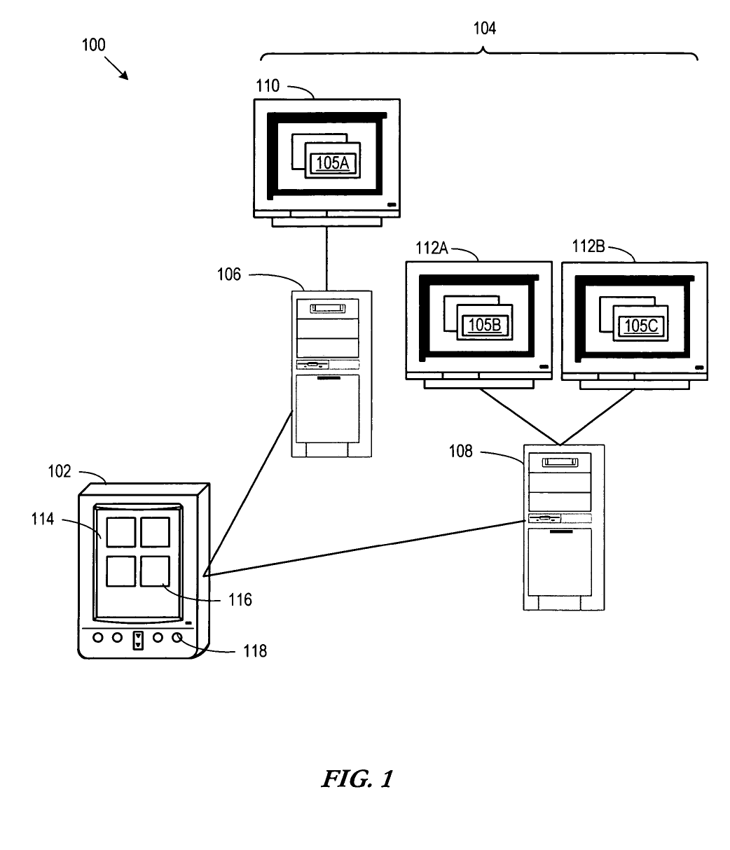

In reference now to FIG. 1, a system 100 is illustrated for providing a user interface control arrangement according to embodiments of the present invention. A general-purpose, handheld computer 102 may be used as a primary input device. The inputs to the handheld computer 102 are used to control one or more applications 105A-C running on a computing arrangement 104. The illustrated computing arrangement 104 includes one or more processing units 106, 108 for processing the applications 105A-C.

In general, the applications 105A-C may be associated with graphical user interfaces (GUI) that provide user interactions via video display and other input/output devices. In the illustrated example, the processing unit 106 controls a display 110, and the processing unit 108 controls two displays 112A and 112B. The GUIs of applications 105A-C running on processing units 106, 108 can be displayed on any combination of displays 110, 112A, and 112B. It will be appreciated that processing units 106, 108 may also control other output devices usable by applications 105A-C. These output devices may include audio cards, indicator lights, printers, data storage devices, robotic devices, etc.

Even though processing units 106, 108 may be used with input devices known in the art (e.g., keyboards, trackballs), the processing units 106, 108 in the illustrated system 100 may be configured to respond to inputs from the handheld computer 102. For example, one of the processing units 106 may be a small, wearable computer with few physical connections due to size limitations. The display 110 of the processing unit 106 may be head-wearable with a small video output device near one or both of the user's eyes. In such an arrangement, the handheld computer 102 may be used as a dynamically configurable input device that simulates various input devices that would otherwise be connected to the processing unit 106: In another arrangement, the computers 102 and 106 may be included in the same piece of hardware.

In another example, the handheld computer 102 can provide a mobile and configurable input device that can be used in locations such as a large meeting room. In this case, the user could control a large and complex display that would normally require a mouse and keyboard, but do so using a small unobtrusive device. Because the device (e.g., the handheld computer 102) can have a dynamically configurable display, the device can provide an abstraction of display data and communicate additional facts about the display that would not be available using standard input devices.

The handheld device 102 includes a display 114 that can show control components 116. In general, the control components 116 may be GUI elements shown in custom graphical display, or GUI components of a general-purpose windowed environment running on the handheld device 102. The control components 116 may contain graphical components that abstract various elements of the application GUIs 105A-C. The control components 116 may generate GUI events usable on the computing arrangement 104 (e.g., mouse and keyboard inputs) that can used to control all of the applications 105A-C.

It will be appreciated that the control components 116 may also be non-graphical components. The control components 116 may, for example, receive user input such as voice or motion. The handheld device 102 may translate these inputs to emulated device data of the computing arrangement 104. Voice inputs may be translated using a voice recognition module into emulated keyboard (e.g., text) data. Motion inputs, which may be provided via devices such as touchpads or accelerometers, may be translated to computer mouse (e.g., vector) inputs.

Events originating at the control components 116 may be communicated to the computing arrangement 104. The events may be handled, for example, by one or more window managers of the computing arrangement 104 that perform window tasks common to all GUI applications. Window managers typically deal with window operations such as moving, minimizing, maximizing, obtaining focus, etc. The window managers may also be used for other display attributes, such as controlling display of cursors, window decorations, backgrounds, etc.

A window manager of the computing arrangement 104 can receive GUI events communicated from the handheld device 102 and treat these events the same as if the events were from an input device directly coupled to the computing arrangement 104. The handheld device 102 may be able to emulate a wide variety of input devices of the computing arrangement 104. The handheld device 102 may include a display 114 that acts as a touchpad or touchscreen, thereby allowing mouse movements to be emulated directly by touchpad inputs.

The computing arrangement 104 may utilize alternate ways of dealing with input events received from the handheld device 102. In one arrangement, the input events can be treated as emulated input devices of the computing arrangement 104. Therefore, if the input events received from the handheld device 102 include textual inputs, these inputs may be treated as keyboard inputs to the computing arrangement 104. This may be accomplished by utilizing an operating system driver that simulates a keyboard but receives actual input from the handheld device 102 instead of keyboard switches.

The handheld device 102 may also include other input apparatus such as pushbuttons 118 that may be used to generate input targeted for the computing arrangement 104. The handheld device 102 may have adapter ports (not shown) to which any input device known in the art can be attached. By providing a variety of input devices and an interactive display 114, the handheld device 102 can act as a flexible and dynamically configurable input device to control applications 105A-C and other programs running on the computing arrangement 104. Additionally, the inclusion of the control components 116 on the handheld device 102 does not prevent other native applications from running on the handheld device 102.

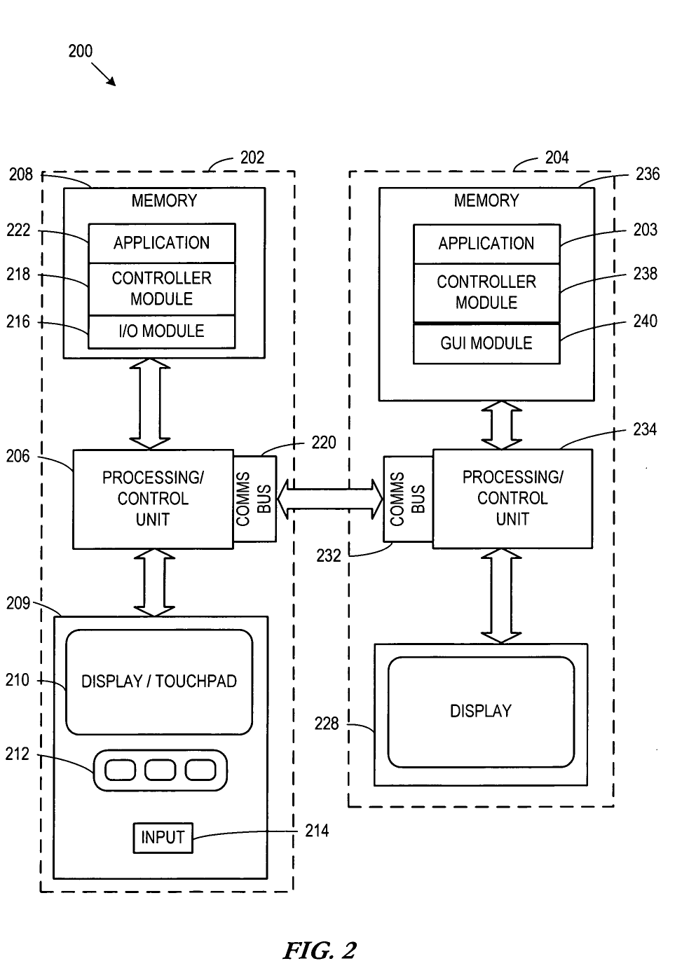

Turning now to FIG. 2, a system diagram 200 illustrates interactions between software and hardware components according to embodiments of the present invention. In FIG. 2, a control device 202 is configured for controlling applications 203 running on a display device 204. The control device 202 may be any general-purpose computer, although a handheld computer may be preferred for many applications. For example, a PDA may be used to provide the functionality of the control device 202. Other computing devices may also be used as a control device 202, including cellular phones, digital cameras, body-wearable computers, laptops, tablet PCs, portable music players, watches, pagers, etc.

The control device 202 has a processing/control unit 206 which may include a central processing unit (CPU) coupled to input/output (I/O), memory, and control busses. The control device 202 includes a memory unit 208 that may include any combination of random access memory (RAM), read-only memory (ROM), magnetic storage, optical storage, flash memory, and any other persistent or non-persistent storage known in the art.

The control device 202 may include any combination of user interface apparatus 209, which may include a display/touchpad 210 and control switches 212. The user interface apparatus 209 may include any additional input/output devices known in the art, as represented by generic device 214. The generic device 214 may include a microphone, speaker, optical reader, electromagnetic or infrared detector/emitter, trackball, potentiometer, sensor, accelerometer, etc.

The control device 202 includes software and/or firmware that may be accessed via the memory 208. This software/firmware includes an I/O module 216 for processing user input and output. Output provided by the I/O module 216 may include at least the displaying of graphical components in the display 210. The I/O module 216 may include various levels of abstraction for displaying graphical components, including low level draw routines and/or high level graphical component libraries.

The I/O module 216 also processes user inputs of the control device 202, including activation of input devices such as the touchpad 210, switches 212, and generic device 214. These inputs may be synchronized with or dependent upon interface outputs. For example, when the touchpad/display 210 detects a stylus input, the location of the input can be mapped to a displayed graphical component, thereby activating a callback function associated with that graphical component. Similarly, the touchpad/display 210 can provide feedback that confirms user input, such as by highlighting the components where input occurred.

The software/firmware of the control device 202 may also include a controller module 218. The controller module 218 handles communications between the control device 202 and the display device 204 for purposes of controlling applications on the display device 204. A communications bus 220 may provide communications between the control device 202 and display device 204. The communications bus 220 may be any inter-device wired or wireless communications channel known in the art, such as RS-232, Universal Serial Bus (USB), IEEE 1394 (Firewire), Ethernet, IEEE 802.11 wireless, infrared, etc.

Data transferred via the communications bus 220 may include user-input data received at the control device 202 and sent to the display device 204. Software running on the display device 204 can receive and interpret this user input data as if it were provided by an input device attached to the display device 204. Data transferred via the communications bus 220 may also include data sent from the display device 204 to the control device 202. Data sent to the control device 202 may include state and control data of the display device 204. State and control data can be used by the control device 202 to dynamically update the display 210 and/or provide custom controls for controlling applications on the display device 204.

The control device 202 may include at least one application 222 that provides interface functions for controlling the display device 204. The application 222 may handle user input and graphical output via the I/O module 216 and establish communications via the controller module 218. The application 222 may display and manage a GUI that handles user inputs and application outputs at the control device 202. The application 222 may also receive other user inputs that are not reflected in the GUI, such as inputs from the switches 212 and generic device 214. The user input can be received by the application 222 and translated to commands sent via the controller module 218. The commands may include emulated device data of the display device 204. The commands can be received at the display device 204 for controlling a graphical display interface.

Data can also be sent from the display device 204 to the application 222 to reflect states and capabilities of software running on the display device 204. The application 222 can use this state data to modify graphical components on the display 210. In this way, the application 222 can provide a dynamically configurable GUI that represents commands that can be issued to the display device 204, as well as reflecting states and capabilities of the display device 204.

The display device 204 may be any general purpose computing arrangement that provides a user interface output device, such as a display 228. One or more applications 203 running on the display device 204 may present a GUI on this display 228. The display device 204 may also contain a processing control unit 234, a communications bus 232, and a memory unit 236. The display device 204 includes software and/or firmware storable in the memory unit 236. This software/firmware may include a communications controller 238, a GUI module 240, and one or more applications 203.

In general, the communications controller 238 can exchange data with the communications controller 218 of the control device 202. The communications controller 238 may receive commands from the control device 202 and emulate an input device of the display device 204. The communications controller 238 may use these commands to manipulate the application 203 via device emulation at the operating system level, and/or through other software such as a window manager.

It will be appreciated that control device 202 and display device 204 may be included on a single apparatus. This apparatus may still include separate displays 210, 228 that provide functionality previously described in association with the control device 202 and display device 204. In such an arrangement, the communication busses 220, 232 may use a software communication mechanism to exchange data between processes. One such software communication mechanism includes inter-process communications (IPC), such as Java RMI, CORBA, Unix pipes, shared memory, TCP/IP, etc. A combined control and display device 202, 204 may use IPC to facilitate communications between the communications controllers 218, 238.

The respective communications controllers 218, 238 of the control and display devices 202, 204 may be configured to exchange generic window events. Window events represent a lowest common denominator of many different window environments, so that the communication controllers 218, 238 could include generic handlers for particular window events. The communication controller 238 may gather window events via the GUI module 240. If status of a window changes (e.g., opened, closed, minimized), then the communication controller 238 can communicate this status to the control device 202.

It will be appreciated that the capability to communicate window events can be extended to communicate any system events or inputs usable by the display device 204. For example, some applications 203 may be able to utilize custom inputs that are not handled by a window manager of the display device 204. For example, the application 203 may be able to handle a stream of audio data provided from the control device 202. This audio stream may be received and processed by the communications controller 238, which may provide this stream to the application 203 via a custom interface and/or by acting as an emulated audio device.

By providing the ability to exchange generic window events, the communications controllers 218, 238 can be used to control many aspects of a GUI on the display device 204. The communications controllers 218, 238 may also include a generic and extensible interface so that an application 203 of the display device 204 can define special input requirements. The application 222 and/or communications controller 218 of the control device 202 can be configured to interpret these requirements and create a custom GUI element for this input.

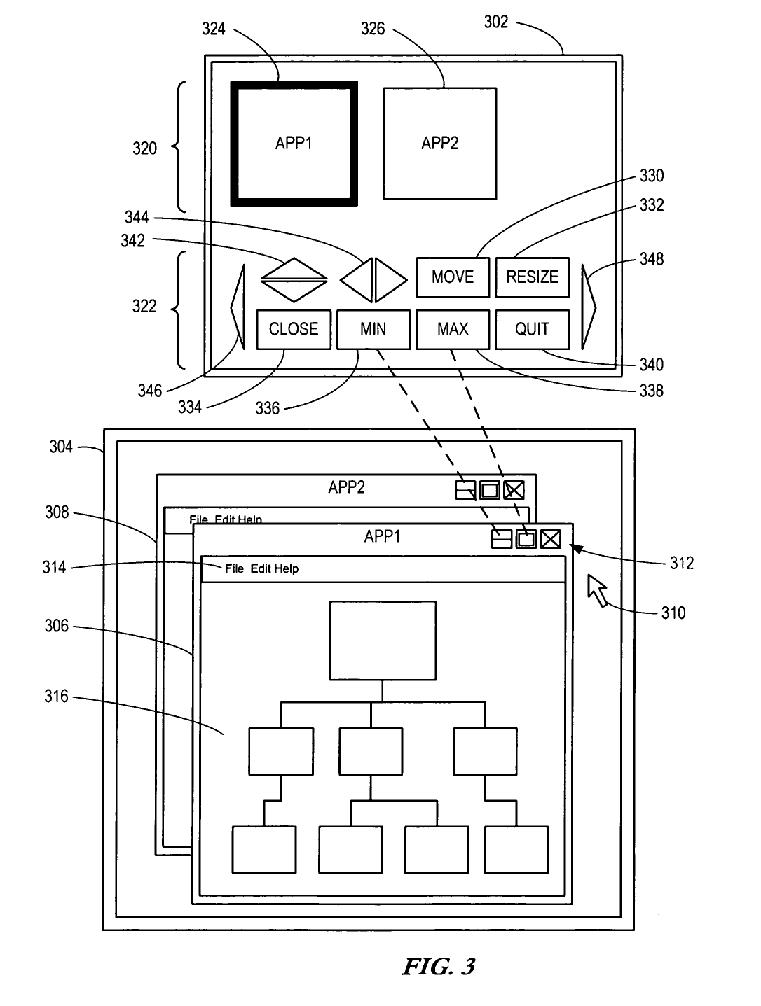

An example of generic interactions between a GUI of a control device and a GUI of a display device is illustrated in FIG. 3 according to embodiments of the present invention. The control GUI 302 is designed for use in a control device such as the unit 202 described in relation to FIG. 2. The control GUI 302 is may be adapted for a small, handheld device using a windowing environment Windows CE®, PalmOS®, X Windows™, etc. The control GUI 302 may receive inputs directly from the display (e.g., via a touchscreen display).

The control GUI 302 is designed to control one or more display GUIs 304. The display GUI 304 may be a standard windowed graphical display such as those provided by Windows®, Mac OS®, X Windows™, BeOS®, etc. The display GUI is shown with two application windows displayed, App1 306 and App2 308. The application App1 306 is currently selected, and is therefore capable of receiving any user input (e.g., keyboard) until another application is selected.

Windows 306, 308 in GUI 304 may be controlled via an input device (e.g., mouse, trackball) that moves the cursor 310. The cursor 310 is used to manipulate applications via window controls 312, menus 314, and/or a rendering area 316 of an application 306. Using arrangements as described herein, the control GUI 302 can also be used to takeover some or all of the functions usually associated with in input device used to control the display GUI 304.

The example control GUI 302 includes a window portion 320 and a control portion 322. The window portion 320 includes graphical components that can be used to select a window of a currently running application. The graphical components of the window portion 320 may be dynamically updated. For example, when a new application window is launched, a new button may appear in the window portion 320. In the illustrated example, buttons 324, 326 correspond to application windows 306 and 308, respectively. Button 324 has a bold outline indicating the respective application window 306 is currently selected.

The control portion 322 can provide various control graphical components that affect the currently selected window. These components may provide the ability move 330, resize 332, close 334, minimize 336, maximize 338, and/or quit 340 application windows. In addition, movement controls such as up/down 342 and left/right 344 may be used in conjunction with other controls such as move 330 and resize 332. The movement controls 342, 344 may also be used for moving the cursor 310.

The control portion 322 may provide additional functions besides those illustrated. For example, graphical components may be provided to launch new applications and/or provide text input to various applications. In the illustrated example, these additional functions may be accessed using scroll controls 346, 348. By pressing one of the scroll controls 346, 348, additional controls are displayed in the control portion 322.

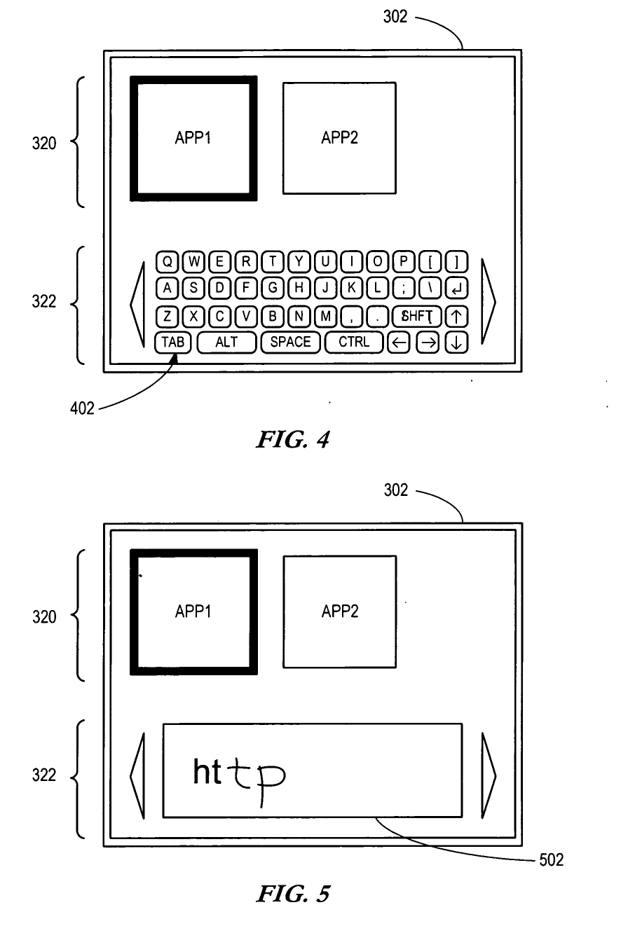

Examples of additional graphical components usable in the control portion 322 are illustrated in FIGS. 4 and 5. In FIG. 4, a touchpad keyboard 402 is displayed in the control portion 322. In FIG. 5, a handwriting recognition writing area 502 is shown in the control portion 322. In both these examples, the user input may be captured by the graphical components and translated into text. This text can be sent as an emulated user input (e.g., keyboard input) to the currently selected application.

It will be appreciated that the inputs described in relation to FIGS. 3-5 can be communicated to a display GUI such as GUI 304 shown in FIG. 3. The inputs may be translated into emulated input device events that are used by the operating system and/or window manager of the display device. Therefore, this technique does not require that any applications running on the display device be aware of the operation of the control device. For example, (referring again to FIG. 3) the display GUI 304 may handle a selection of the application button 320 by invoking a window manager event that results in the App2 window 308 being selected in the display GUI 304. Since this process uses standard window events, App2 308 required no special adaptations to be controlled from the control GUI 302.

In other arrangements, commands sent from the control GUI 304 may be handled at the display GUI 304 by automatically moving the cursor 310 to an appropriate location, and then simulating a mouse button click. This may avoid the need to use window events, and may be implemented as a pure device emulation. Even though this method of mapping control actions is more complex than sending window events, it may be advantageous in some situations. Some applications may not recognize standard window events, or may have actions for which there are no corresponding window events. Also, this method allows the use of unmodified GUI software 304, even if the GUI software has no provisions for accepting window events that have been generated outside of the GUI. In such situations, simulating a mouse movement can initiate any action that can be initiated by a user, regardless of whether the application recognizes a given window manager event.

Of course, users typically spend a small amount of time manipulating GUI windows. A relatively larger amount of time is spent manipulating inputs within an application. The control GUI 302 can be adapted to control specific applications in a number of ways. In the examples of FIGS. 4 and 5, the users can place text directly in an application by selecting an application in the window portion 320 and inputting text using the keyboard 402 and/or handwriting recognition area 502. In general, text input can be handled by the window manager in the display GUI. In response to control GUI commands, the window manager selects the application, and whatever input is provided from the control GUI 302 is sent as default input to the application. It will be appreciated that other forms of input besides text may be applied this way, including inputs originating from or simulating computer mice, touchpads/touchscreens, voice recognition software, biometrics devices, etc.

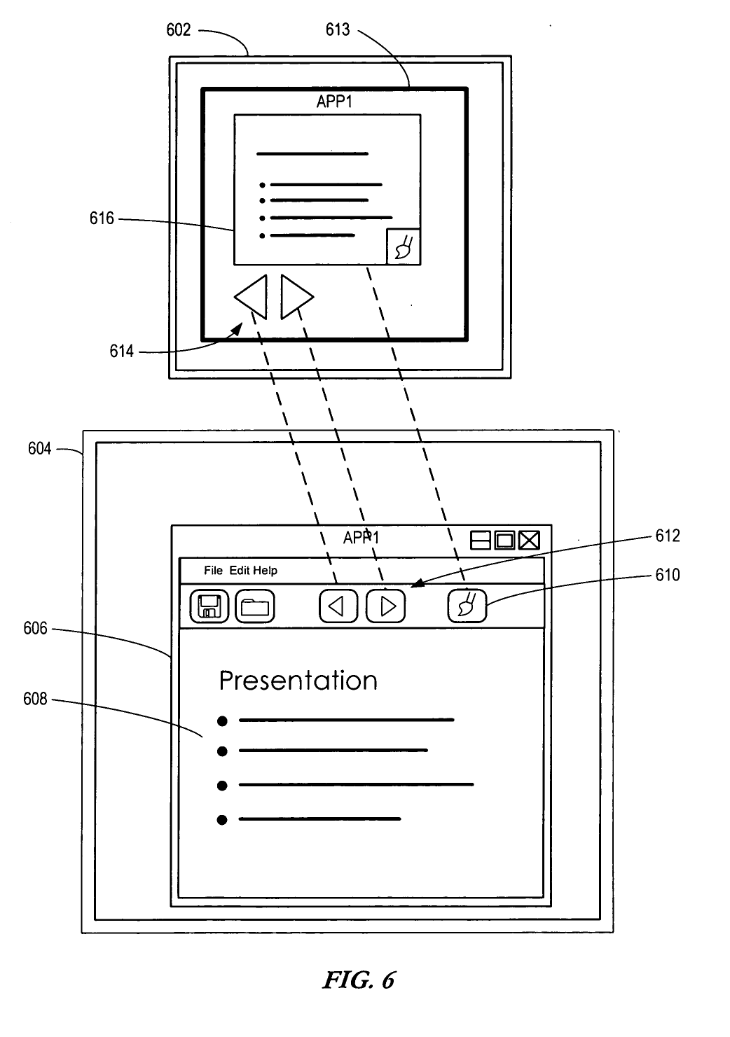

Indirect control of applications may be implemented by using generic window manager events or by controlling an emulated mouse and keyboard. However, in many cases it may be preferable for applications to provide specific controls for direct manipulation of the application via the control GUI. One such example of application-specific controls is illustrated in FIG. 6.

In FIG. 6, a control GUI 602 is used for controlling a display GUI 604. The display GUI 604 has a single application window 606 running. The control GUI 602 contains controls that are used specifically for controlling the application window 606. It will be appreciated that the control GUI 602 may include any combination of generic (e.g., window event, device emulation) and application-specific controls.

For purposes of this example, it will be assumed this application window 606 is a presentation and collaboration program. The application 606 includes a display area 608 where graphics and text are shown. During a presentation, the presenter may perform certain actions on the display area 608, such as highlighting text or drawing on the display area 608. The application may contain a drawing button 610 for entering drawing mode and navigation controls 612 used to advance slides during a presentation.

The application window 606 may utilize its own data connection to the control GUI 602. The application window 606 may pass data to the control GUI 602 usable for drawing graphical components in the control GUI 602. This data may be in any form, including a description (e.g., XML formatted data structure), an executable object (e.g., ActiveX® control or JavaBean®), or any combination thereof. In other arrangements, the control GUI 602 may have pre-loaded controls that are able to control this application window 606.

In the illustrated example, the control GUI 602 includes an application-specific area 613. This application-specific area 613 includes forward/reverse buttons 614 that are mapped to the navigation controls 612. Similarly, a drawing area 616 may be used to enter a drawing mode as provided by the drawing button 610. The drawing area 616 may include a simplified image (e.g., bitmap) that represents the current image in the display area 608. This simplified image may provide a rough drawing guide for the user. As the user draws on the drawing area 616, the display area 608 of the application 606 displays a rendering of the drawing.

It will be appreciated that many application-specific controls may be implemented in the control GUI 602. The drawing area 608 may also be used for actions such as zooming, highlighting, selecting, scrolling, etc. The application 606 may export other controls to the control GUI 602, such as menus, selection boxes, context-sensitive menus, tool-tips, etc. If the application 606 includes a large number of exportable controls, the application 606 and/or control GUI 602 may provide a way of choosing and arranging a subset of the available controls to suit a particular purpose.

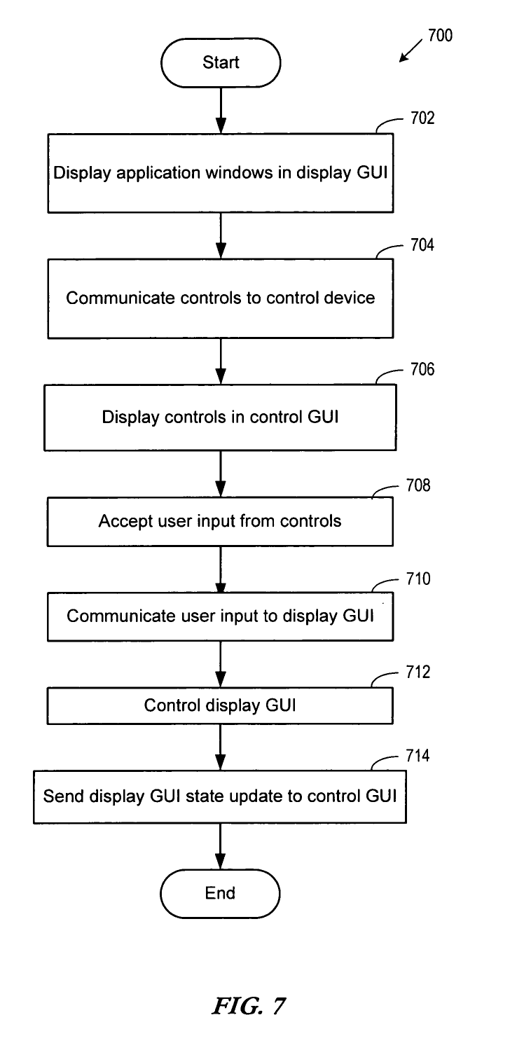

Turning now to FIG. 7, a high-level flowchart 700 illustrates aspects of controlling a display GUI according to embodiments of the present invention. In this example, one or more application windows are shown (702) in a display GUI. The display GUI is typically provided by a display device. The display device communicates (704) control data based on the display GUI to a control device. The control data may include data used for forming/drawing the controls, as well as state data of the display GUI. This communication (704) may originate from the operating system/window manager of the display device, and may also originate from one or more application windows. Either the control device or display device may initiate the communication (704).

The control device can display (706) the controls in a control GUI of the control device based on the control data. The controls can then be used to accept (708) user input at the control device. The user input is communicated (710) to the display GUI, which is then used to control (712) the display GUI. The control 10 (712) of the display GUI may involve some change of state of the display GUI (e.g., application selected or closed). Data that describes the display GUI state may be sent (714) to the control GUI. It will be appreciated that, in situations where there are no communications from the display GUI to the control GUI, the sending (704, 714) of control data and state data to the control GUI would be not be required.

From the description provided herein, those skilled in the art are readily able to combine hardware and/or software created as described with appropriate general purpose or system and/or computer subcomponents embodiments of the invention, and to create a system and/or computer subcomponents for carrying out the method embodiments of the invention. Embodiments of the present invention may be implemented in any combination of hardware and software.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention not be limited with this detailed description, but rather the scope of the invention is defined by the claims appended hereto.

1. A method for interfacing with a graphical user interface having a plurality of functional components, comprising:
displaying the graphical user interface on a first computing arrangement;
providing via a second computing arrangement a control component that abstracts a function of one of the plurality of functional components of the graphical user interface;
receiving a user input via the control component;
translating the user input to a data set that emulates data from an input device of the first computing arrangement;
communicating the data set to the first computing arrangement; and
controlling of the associated portions of the graphical user interface based on the data set.

2. The method of claim 1, further comprising:
communicating a state of the graphical user interface of the first computing arrangement to the second computing arrangement; and
updating the control component of the second computing arrangement based on the state of the graphical user interface.

3. The method of claim 1, wherein providing the control component via the second computing arrangement comprises displaying a control graphical component on a display of the second computing arrangement.

4. The method of claim 1, wherein the graphical user interface of the first computing arrangement comprises a windowed graphical user interface.

5. The method of claim 1, wherein the second computing arrangement comprises a handheld data processor.

6. The method of claim 5, wherein the handheld data processor comprises a Personal Digital Assistant (PDA).

7. The method of claim 1, wherein receiving user input comprises receiving user input via strokes on a touchpad, and translating the user input comprises translating the user input to data that emulates data from a mouse of the first computing arrangement.

8. The method of claim 1, wherein receiving user input comprises receiving user input via a handwriting recognition module, and translating the user input comprises translating the user input to data that emulates data from a keyboard of the first computing arrangement.

9. The method of claim 1, wherein receiving user input comprises receiving user input via a voice recognition module, and translating the user input comprises translating the user input to data that emulates data from a keyboard of the first computing arrangement.

10. The method of claim 1, wherein controlling the associated portions of the graphical user interface comprises emulating the input device on the first computing arrangement based on the data set.

11. The method of claim 1, wherein communicating the data set to the first computing arrangement comprises communicating via a network connection.

12. The method of claim 11, wherein the network connection comprises a wireless network connection.

13. The method of claim 1, wherein communicating a data set to the first computing arrangement comprises communicating via a wireless connection.

14. The method of claim 13, wherein the wireless connection includes an infrared connection.

15. A system, comprising:
a display arrangement configured to display a graphical user interface having a plurality of functional components;
a control arrangement having a control component that abstracts a function of one of the plurality of functional components, the control arrangement configured to receive a user input via the control component and translate the user input to a data set that emulates data of a computer input device;
a computing arrangement coupled to the display arrangement and the control arrangement, including,
a memory configured with a program; and
a processor coupled to the memory, the program when executed by the processor causing the processor to,
display the graphical user interface on the display arrangement;
receive the data set from the control arrangement; and
control the graphical user interface based on the data set.

16. The system of claim 15, wherein the program further causes the processor to communicate a state of the graphical user interface to the control arrangement, and wherein the control component of the control arrangement is updated based on the state of the graphical user interface received via the computing arrangement.

17. The system of claim 15, wherein the control arrangement comprises a handheld data processor.

18. The system of claim 17, wherein the handheld data processor comprises a Personal Digital Assistant (PDA).

19. The system of claim 15, wherein control arrangement includes a touchpad, and the data set includes emulated mouse data formed from an output of the touchpad.

20. The system of claim 15, wherein the control arrangement includes a handwriting recognition module and the data set includes emulated keyboard data formed from an output of the handwriting recognition module.

21. A computer-readable medium configured with instructions for causing a processor of a data processing arrangement to perform steps comprising:
displaying one or more control graphical components on a control user interface of the data processing arrangement that abstract functions a proper subset of graphical components of a second data processing arrangement;
associating the control graphical components with the proper subset of graphical components;
receiving a user input of the data processing arrangement via the control graphical components;
translating the user input to a data set that emulates data from an input device of the second data processing arrangement; and
communicating the data set to the second data processing arrangement for control of the subset of graphical components of the second data processing arrangement.

22. The computer-readable medium of claim 21, wherein the steps further comprise:
receiving a state of the subset of graphical components of the second data processing arrangement; and
updating the control graphical components based on the state of the subset of graphical components.

23. The computer-readable medium of claim 21, wherein receiving a user input of the data processing arrangement includes receiving a user input via a touchpad.

24. The computer-readable medium of claim 21 wherein receiving a user input of the data processing arrangement includes receiving a user input via a handwriting recognition module.

25. A system comprising:
means for displaying a graphical user interface of an application;
means for displaying a control interface having components that abstract functions of a proper subset of components of the graphical user interface;
means for receiving user inputs via the control interface;
means for communicating the user inputs to control the proper subset of components of the graphical user interface; and
means for communicating a state of the proper subset of components of the graphical user interface to update the components of the control interface.

26. A method for interfacing with a graphical user interface, comprising:
displaying the graphical user interface on a first computing arrangement;
providing on a second computing arrangement one or more control components that abstract functions of a proper subset of graphical components of the graphical user interface;
associating the control components with the proper subset of graphical components;
receiving a user input via the control components of the second computing arrangement;
communicating the user input to the first computing arrangement for control of the associated portions of the graphical user interface;
communicating a state of the graphical user interface of the first computing arrangement to the second computing arrangement; and
updating the control components of the second computing arrangement based on the state of the graphical user interface.

27. The method of claim 26, wherein communicating the user input to the first computing arrangement comprises communicating via a wireless connection.

28. The method of claim 27, wherein the wireless connection includes a wireless network connection.

29. The method of claim 27, wherein the wireless connection includes an infrared connection.
